(19) United States
(12) Patent Application Publication
(10) Pub. No.: US 2009/0065731 A1
(43) Pub. Date: Mar. 12, 2009

(54) Method for producing piezoelectric ceramic

(75) Inventors: Keisuke Teranishi, Tokyo (JP); Tomohisa Azuma, Tokyo (JP); Masakazu Hirose, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/230,677

(22) Filed: Sep. 3, 2008

(30) Foreign Application Priority Data
Sep. 6, 2007 (JP) 2007-230937

(51) Int. Cl. C04B 35/46

(52) U.S. Cl. 252/62.9 PZ

(57) ABSTRACT

To provide a method for producing a piezoelectric ceramic which can improve toughness thereof. Provided is a method for producing a piezoelectric ceramic which includes a step of polarizing a piezoelectric ceramic having a main component represented by a composition formula Pbₐ[(Mn_{b}Nb_{c})_{d}TiₑZr_{f}]O₃, wherein a to f satisfy 0.98≦a≦1.01, 0.340≦b≦0.384, 0.616≦c≦0.660, 0.08≦d≦0.12, 0.500≦e≦0.540, 0.37≦f≦0.41, and bd+cd+e+f=1, and 1 to 10% by weight of Al in terms of Al₂O₃ as an additive, and heat-treating the polarized piezoelectric ceramic for 10 to 60 minutes in a range of 200 to 300° C. As a result of this heat treatment, toughness of the piezoelectric ceramic can be improved.

### BACKGROUND OF THE INVENTION

1. Field of the Invention

The present invention relates to a method for producing a piezoelectric ceramic, more specifically, relates to a production method which includes a heat treatment for improving toughness of a piezoelectric ceramic.

2. Description of the Related Art

Piezoelectric ceramics are widely used as a material for piezoelectric elements such as resonators, filters, actuators, ignition devices, ultrasonic motors or the like. Most piezoelectric ceramics which are currently used in practice are formed from a ferroelectric substance having a perovskite structure, such as a PZT (PbZrO₃—PbTiO₃ solid solution) system or PT (PbTiO₃) system which is tetragonal or rhombohedral at around room temperature.

Recently, along with the miniaturization of electronic devices which include a communication device, surface mounting has been rapidly progressing. During surface mounting, a piezoelectric element which is temporarily mounted on a printed board is soldered thereto. After the soldering process, which involves applying heat, it is desirable that the properties of the piezoelectric element (e.g., resonant frequency, oscillation frequency etc.) do not substantially differ from the initial properties. Accordingly, various investigations have been carried out for improving the heat resistance of a piezoelectric ceramic (e.g., Japanese Patent Laid-Open Nos. 2005-119944 and 2007-1841).

Japanese Patent Laid-Open No. 2005-119944 proposes a production method which includes a polarization treatment step of carrying out a polarization treatment on a piezoelectric ceramic containing a perovskite compound having Pb, Zr, Ti, Mn, and Nb as main components, and a heat treatment step of retaining the polarized piezoelectric ceramic within the temperature range of 0.68Tc or more to less than Tc (wherein Tc is the Curie temperature of the piezoelectric ceramic) for 1 to 100 minutes.

Japanese Patent Laid-Open No. 2007-1841 proposes a piezoelectric ceramic formed from a sintered compact which contains a main component represented by Pbₐ[(Mn_{1/3}Nb_{2/3})ₓTi_{y}Zr_{z}]O₃ (wherein 0.97≦a≦1.01, 0.04≦x≦0.16, 0.48≦y≦0.58, and 0.32≦z≦0.41), and Al as an additive, wherein the mean crystal grain size of the sintered compact is 1.0-4.0 μm.

### SUMMARY OF THE INVENTION

With the miniaturization of electronic devices, in addition to heat resistance, piezoelectric ceramics also now need to have improved toughness. In particular, this is to suppress processing defects such as chips and cracks during the dicing step and lapping step of a thin piezoelectric ceramic having a thickness of 1 mm or less, and especially, of 0.5 mm or less. Further, this is also to prevent a piezoelectric ceramic from being damaged if it subjected to a shock by being dropped during the production steps. However, Japanese Patent Laid-Open Nos. 2005-119944 and 2007-1841 give no suggestions concerning how to improve toughness thereof.

The present invention was created based on such technical problems, and it is an object of the present invention to provide a method for producing a piezoelectric ceramic which can improve heat resistance and toughness.

The present invention is a method for producing a piezoelectric ceramic comprising the steps of polarizing a piezoelectric ceramic comprising a main component represented by a composition formula Pbₐ[(Mn_{b}Nb_{c})_{d}TiₑZr_{f}]O₃, wherein a, b, c, d, e and f satisfy 0.98≦a≦1.01, 0.340≦b≦0.384, 0.616≦c≦0.660, 0.08≦d≦0.12, 0.500≦e≦0.540, 0.37≦f≦0.41, and bd+cd+e+f=1, and 1 to 10% by weight of Al in terms of Al₂O₃ as an additive; and heat-treating the polarized piezoelectric ceramic for 10 to 60 minutes at 200 to 300° C.

The present invention improves toughness by heat-treating a piezoelectric ceramic with a specific composition, which has been subjected to a polarization treatment. The effects of this improvement in toughness are marked if b in the above composition formula is such that 0.340≦b≦0.384 and c in the above composition formula is such that 0.616≦c≦0.660.

In the present invention, the heat treatment is preferably conducted in a temperature range of 260 to 300° C., and preferably for 20 to 40 minutes.

According to the present invention, toughness can be improved by subjecting a polarized piezoelectric ceramic to a heat treatment for 10 to 60 minutes at 200 to 300° C. Therefore, processing defects during the dicing step and lapping step can be suppressed. Thus, the present invention can achieve an improvement in processing speed. Further, a piezoelectric ceramic can be obtained which is strong against shocks from drops or the like which occur during the production steps.

### BRIEF DESCRIPTION OF THE DRAWINGS

FIGS. 1A and 1B are diagrams illustrating the appearance of the specimen fabricated in the Examples;

FIG. 2 is an exploded perspective view illustrating the structure of the resonator fabricated in the Examples;

FIG. 3 is a graph illustrating the waveform when spurious vibrations are present;

FIG. 4 is a graph illustrating the waveform when spurious vibrations are not present; and

FIG. 5 is a graph illustrating the relationship between the heat treatment temperature and the fracture toughness value k1C.

### DETAILED DESCRIPTION OF THE PREFERRED EMBODIMENTS

The production method of a piezoelectric ceramic according to the present invention will now be described in more detail.

### <Piezoelectric Ceramic Composition>

First, the composition of the piezoelectric ceramic to which the present invention is directed will be described.

The main component of the piezoelectric ceramic produced according to the present invention is represented by the following composition formula. This main component is composed of a perovskite compound. Composition formula: Pbₐ[(Mn_{b}Nb_{c})_{d}TiₑZr_{f}]O₃

In the formula, a, b, c, d, e and f satisfy the following. Here, a, b, c, d, e and f all represent molar ratios.

0.98≦a≦1.01, 0.340≦b0.384, 0.616≦c≦0.660, 0.08≦d≦0.12, 0.500≦e≦0.540, 0.37≦f≦0.41, and bd+cd+e+f=1

The reasons why a, b, c, d, e and f are defined in the above ranges are as follows.

### <Pb>

The value of a, which represents the amount of Pb, is in the range of 0.98≦a≦1.01. If a is less than 0.98, it is difficult to obtain a dense sintered body. On the other hand, if a is more than 1.01, good heat resistance cannot be obtained. a is preferably such that 0.985≦a≦1.005, and is more preferably such that 0.985≦a≦1.000.

### <Mn, Nb>

The stoichiometric composition of Mn and Nb in the perovskite compound having Pb, Zr, Ti, Mn, and Nb as main components is Mn_{1/3}Nb_{2/3}. Japanese Patent Laid-Open No. 2005-119944 employs a stoichiometric composition for Mn and Nb. In contrast, the present invention employs a composition in which the Mn is richer than the stoichiometric amount, and the Nb is poorer than the stoichiometric amount. A composition in which the Mn is richer than the stoichiometric amount and the Nb is poorer than the stoichiometric amount can be defined such that b is 0.340≦b≦0.384 and c is 0.616≦c≦0.660. A piezoelectric ceramic having this composition range has a higher effect on toughness improvement resulting from the heat treatment of the present invention than a piezoelectric ceramic in which the Mn and Nb are present in stoichiometric amounts. Further, by employing this composition range, the heat resistance of the piezoelectric ceramic is improved.

If b is less than 0.34° (c is more than 0.660), the effect on toughness improvement according to the present invention is small, and excellent heat resistance can no longer be obtained. Further, if b is more than 0.384 (c is less than 0.616), ohmic resistance is reduced, whereby polarization becomes impossible. Preferably, b is such that 0.345≦b≦0.375 and c is such that 0.625≦c≦0.655. More preferably, b is such that 0.345≦b≦0.370 and c is such that 0.630≦c≦0.655.

The value of d, which represents the total amount of Mn and Nb in the above composition formula, is in the range of 0.08≦d≦0.12. If d is less than 0.08, the electrical property Qₘₐₓ becomes smaller. On the other hand, if d is more than 0.12, good heat resistance cannot be obtained. Accordingly, d is such that 0.085≦d≦0.12, preferably such that 0.085≦d≦0.115, and is more preferably such that 0.09≦d≦0.11.

### <Ti>

The value of e, which represents the amount of Ti, is in the range of 0.500≦e≦0.540. If e is less than 0.500, good heat resistance cannot be obtained. On the other hand, if e is more than 0.540, the electrical property Qₘₐₓ becomes smaller. e is preferably such that 0.505≦e≦0.535, and is more preferably 0.505≦e≦0.520.

### <Zr>

The value of f, which represents the amount of Zr, is in the range of 0.37≦f≦0.41. If f is less than 0.37, the electrical property Qₘₐₓ becomes smaller. If f is more than 0.41, good heat resistance cannot be obtained. Therefore, while f is in the range of 0.37≦f≦0.41, preferred is 0.380≦f≦0.405, and more preferred is 0.385≦f≦0.400.

The present invention comprises the above as a main component, and further comprises 1 to 10% by weight of Al in terms of Al₂O₃ as an additive.

The electromechanical coupling factor of a piezoelectric ceramic can be reduced by adding Al₂O₃. This is suitable when the piezoelectric ceramic produced according to the present invention is used for a resonator. Like other electronic components, resonators continue to decrease in size. Miniaturized resonators sometimes cannot adequately confine the main vibration. Therefore, in such resonators, unnecessary vibrations (spurious vibrations) are likely to occur. Here, the expression “confine the main vibration” refers to the state wherein a single vibration is generated on the vibrating electrode sections formed on both surfaces of the piezoelectric body, whereby vibrations are attenuated in the sections (non-electrode sections) free from a vibrating electrode so that unnecessary vibrations are scarcely present. If the piezoelectric element is large, vibrations can be sufficiently attenuated since the non-electrode sections can be large. However, for a small resonator, there are less non-electrode sections. In such case, the vibrations might not be sufficiently attenuated, whereby unnecessary vibrations are more likely to occur. If unnecessary vibrations increase, when the electromechanical coupling factor of the piezoelectric material is large, the frequency of the main vibration and that of the unnecessary vibrations overlap or approximate each other, which makes it more difficult to confine only the main vibration. While it is possible to separate the frequency of the main vibration and that of the unnecessary vibrations by reducing the electromechanical coupling factor, the Al₂O₃ in the present invention can also deal with this issue. Further, as is illustrated in the following Examples, the piezoelectric ceramic produced according to the present invention comprising a predetermined amount of Al₂O₃ is effective for resonator miniaturization because unnecessary vibrations can be suppressed.

A preferred Al₂O₃ amount is 2 to 6% by weight, and a more preferred Al₂O₃ amount is 2 to 4% by weight. If the Al₂O₃ is in this range, the below-described heat resistance |ΔF₀| can be made especially small. Further, if the Al₂O₃ amount is 6% by weight or less, the electrical property Qₘₐₓ can be 80 or higher, and if the Al₂O₃ amount is 4% by weight or less, the electrical property Qₘₐₓ can be 90 or higher.

### <Production Method>

The present invention subjects a piezoelectric ceramic having the above composition to a certain heat treatment, which will now be described below. This heat treatment is carried out on a piezoelectric ceramic which has been subjected to a polarization treatment. Carrying out the heat treatment after a polarization treatment allows a polarized state having a higher heat resistance to be realized, and is also effective in reducing the below-described |ΔF₀|. Further, although the below-described electromechanical coupling factor k₁₅ is a property which is exhibited after polarization, this electromechanical coupling factor k₁₅ can be reduced as a result of the heat treatment of the present invention, which allows a preferred state for a resonator to be achieved. The steps until the polarization treatment and the steps after the heat treatment will be described below.

The heat treatment temperature of the heat treatment in the present invention is selected in the range of 200 to 300° C. If the heat treatment temperature is less than 200° C., the effects of an improvement in toughness are insufficient. Although toughness increases as the heat treatment temperature increases, conversely, the electrical property Qₘₐₓ decreases. Therefore, the heat treatment temperature is set at 300° C. or less. If the principal objective is to obtain an effect on toughness improvement, the heat treatment temperature is preferably 250 to 300° C., more preferably 260 to 300° C., and still more preferably 270 to 290° C. In addition, as long as it is within the above range, the heat treatment temperature does not have to be fixed, and may be varied.

The heat treatment time is between 10 and 60 minutes. If the heat treatment time is less than 10 minutes, the effects of an improvement in toughness cannot be sufficiently enjoyed. On the other hand, because the effects of an improvement in toughness level off at about 60 minutes, heat treatment any longer than that is a hindrance on productivity and needlessly consumes thermal energy. Further, carrying out a prolonged heat treatment at a high temperature in the above temperature range is a factor in causing the electrical property Qₘₐₓ to decrease. Accordingly, the present invention sets the heat treatment time to between 10 and 60 minutes. The specific heat treatment time may be appropriately set in balance with the heat treatment temperature. The atmosphere for carrying out the heat treatment is not especially limited, and may be N₂ or air.

Next, a preferred embodiment of the method for producing a piezoelectric ceramic will be described in order of its steps.

### (Raw Material Powders and Weighing Out)

Used as the raw materials for the main component are powders of oxides or of compounds which are converted to oxides when heated. More specifically, PbO powder, TiO₂ powder, ZrO₂ powder, MnCO₃ powder, Nb₂O₅ powder and the like can be used. The raw material powders are each weighed to form the composition according to the above-described composition formula. Then, based on the total weight of the main component raw material powders which were weighed, 1 to 10% by weight of Al₂O₃ powder as an additive raw material powder is added. The mean particle size of the raw material powders may be appropriately selected in the range of 0.1 to 3.0 μm.

Moreover, without being limited to the above described raw material powders, a powder of a composite oxide containing two or more metals may also be used as a raw material powder.

### (Calcination)

The raw material powders are subjected to wet mixing, and the resultant mixture is then calcined while being retained at a temperature in the range of 700 to 950° C. for a predetermined period of time. The atmosphere during calcination may be N₂ or air. The retention time for the calcination may be appropriately selected in the range of 0.5 to 5 hours. The calcined body is milled after the calcination.

It was described above that the raw material powders of the main component are mixed together with the raw material powder of the additive and then the resultant mixture is subjected to calcination. However, the timing for adding the raw material powder of the additive is not limited to the above-described timing. For example, first, the powders of the main component may be weighed, mixed, calcined and milled, and then, to the main component powder obtained by grinding, the raw material powder of the additive may be added in a predetermined amount and mixed therein.

### (Granulation and Compacting)

The milled powder is formed into granules for the purpose of smoothly carrying out the subsequent compacting step. At this time, a small amount of an appropriate binder, for example polyvinyl alcohol (PVA) is added to the milled powder, and the resultant mixture is sufficiently mixed and granulated through a mesh, for example. The resultant granulated powder is then compacted by pressing at a pressure of 200 to 300 MPa to obtain a compact having a desired shape.

### (Sintering)

After the binder added during compacting has been removed, the compact is heated and retained at a temperature in the range of 1,170 to 1,250° C. for a predetermined period of time to obtain a sintered body. The atmosphere during sintering may be N₂ or air. The retaining time period of the heating may be appropriately set in the range of 0.5 to 4 hours.

### (Polarization)

After the temporary electrodes used for polarization have been formed on the sintered body, polarization is carried out. The polarization is conducted at a temperature of 50 to 300° C. by applying an electric field of 1.0 to 2.0 Ec (Ec being the coercive field) to the sintered body for 0.5 to 30 minutes.

The polarization is conducted in a bath of an insulating oil such as silicon oil heated to the above described temperature.

The sintered body (piezoelectric ceramic) is lapped to a desired thickness, and then the piezoelectric ceramic is subjected to the above-described heat treatment. During this heat treatment, the temporary-electrodes used for polarization may be left or may be removed. After being subjected to the heat treatment, vibrating electrodes are formed on the piezoelectric ceramic. Then, after cutting into a desired shape with a dicing saw or the like, the piezoelectric ceramic can function as a piezoelectric element. The piezoelectric ceramic produced according to the present invention can be suitably used especially for a resonator.

### <Properties of the Piezoelectric Ceramic>

By subjecting the piezoelectric ceramic obtained by the present invention to a heat treatment, toughness thereof is improved.

Further, the piezoelectric ceramic obtained by the present invention can have improved heat resistance as a result of employing a composition in which the Mn of 0.340≦b≦0.384 is richer than the stoichiometric amount, and the Nb of 0.616≦c≦0.660 is poorer than the stoichiometric amount. Further, if Mn and Nb have such a composition, the effects of an improvement in heat resistance are marked.

### (Toughness)

In the present invention, toughness is evaluated in terms of fracture toughness value k1C. The fracture toughness value k1C can be measured according to the fracture toughness test method of a fine ceramic specified in JIS R1607.

### (Heat Resistance)

The piezoelectric ceramic of the present invention exhibits excellent heat resistance as a result of employing a composition in which the Mn is richer than the stoichiometric amount, and the Nb is poorer than the stoichiometric amount. In the present invention, heat resistance was evaluated based on oscillation frequency F₀. Specifically, heat resistance was evaluated in terms of the absolute value |ΔF₀| of the rate of change (ΔF₀) in oscillation frequency F₀ according to the following formula 1.

$$Δ {F}_{0} = \frac{{F}_{0} ( after test ) - {F}_{0} ( before test )}{{F}_{0} ( after test )} \times 100 ( \% ) \qquad [ Formula 1 ]$$

F₀ (before test): Oscillation frequency measured before application of a thermal shock.
F₀ (after test): Oscillation frequency measured after application of a thermal shock, which was obtained as follows: wrapping a sample whose F₀ (before test) had been measured in aluminum foil, immersing the sample in a solder bath at 265° C. for 10 seconds (thermal shock application), then taking the sample out from the aluminum foil and leaving the sample to stand in air at room temperature for 24 hours, and then measuring oscillation frequency F₀.

The piezoelectric ceramic produced according to the present invention may have a heat resistance |ΔF₀| relating to the oscillation frequency F₀ of 0.05% or less, and further of 0.03% or less. Here, the oscillation frequency F₀ is defined by the following formulas 2 to 5 employing equivalent circuit constants. In formulas 2 to 5, F₀ represents the oscillation frequency, Fr represents the resonant frequency, Fa represents the anti-resonant frequency, C₁ represents the motional capacitance, C₀ represents the shunt capacitance, C_{L} is defined in formula 5, Cd represents a free capacitance, and C_{L1} and C_{L2} each represent a load capacitance. As shown in formula 2, four parameters, resonant frequency Fr, motional capacitance C₁, shunt capacitance C₀ and C_{L} affect the value of the oscillation frequency F₀. Further, as shown in formulas 3 to 5, motional capacitance C₁, shunt capacitance C₀ and C_{L} are each associated with plural parameters.

$$\begin{matrix}{F}_{0} = Fr \sqrt{1 + \frac{{C}_{1}}{{C}_{0} + {C}_{L}}} & [ Formula 2 ] \\ {C}_{1} = \frac{{Fa}^{2} - {Fr}^{2}}{{Fa}^{2}} Cd & [ Formula 3 ] \\ {C}_{0} = Cd - {C}_{1} & [ Formula 4 ] \\ {C}_{L} = \frac{{C}_{L 1} \cdot {C}_{L 2}}{{C}_{L 1} + {C}_{L 2}} ⇒ \frac{{C}_{L 1}}{2} ( {C}_{L 1} = {C}_{L 2} ) & [ Formula 5 ]\end{matrix}$$

(Electromechanical Coupling Factor k₁₅)

In the present invention, the electromechanical coupling factor was determined as one of the piezoelectric properties. The electromechanical coupling factor is a constant representing the energy converting efficiency of the piezoelectric with which the electrical energy applied between the electrodes of a piezoelectric body is converted into mechanical energy. For example, for actuator applications and ultrasonic applications, a large electromechanical coupling factor is desirable. On the other hand, it is desirable for the resonating element of a piezoelectric resonator to have a small electromechanical coupling factor. The electromechanical coupling factor in the piezoelectric ceramic produced according to the present invention can be adjusted by including Al₂O₃ as an additive. Specifically, the electromechanical coupling factor can be decreased by increasing the amount of Al₂O₃.

In the present invention, the resonant frequency Fr and anti-resonant frequency Fa were measured in the vicinity of about 4 MHz using the impedance analyzer (4294A manufactured by Agilent Technologies). The electromechanical coupling factor k₁₅ was determined according to the following formula 6.

$${k}_{15} = \sqrt{\frac{π}{2} \cdot \frac{Fr}{Fa} cot ( \frac{π}{2} \cdot \frac{Fr}{Fa} )} \qquad [ Formula 6 ]$$

### (Electrical Property Qₘₐₓ)

The electrical property Qₘₐₓ represents the maximum value of Q (=tan θ; θ being the phase angle (deg)) between the resonant frequency Fr and anti-resonant frequency Fa. The electrical property Qₘₐₓ is an important property of a resonator. The higher this value is, the lower the voltage capable of driving the device is.

### EXAMPLE 1

As the raw materials, prepared were lead oxide (PbO) powder, titanium oxide (TiO₂) powder, zirconium oxide (ZrO₂) powder, manganese carbonate (MnCO₃) powder, niobium oxide (Nb₂O₅) powder and aluminum oxide (Al₂O₃) powder. These raw material powders were weighed so as to form the compositions shown in Tables 1 to 4, and the resultant mixtures were the wet-mixed in pure water for 0.5 hours by a ball mill (using Zr balls).

The obtained slurry was sufficiently dried, compacted by pressing and then calcined in air at 800 to 950° C. Then, the calcined body was finely milled by a ball mill to have a mean particle size of 0.7 μm, and the finely milled powder was then dried. The dried, finely milled powder was charged with an appropriate amount of PVA (polyvinyl alcohol) as a binder, and the resultant mixture was granulated.

About 3 g of the granulated powder was charged into a die cavity having a 20 mm length and a 20 mm width, and then compacted under a pressure of 245 MPa using a uniaxial press machine. The obtained compacted body was subjected to a treatment for removing the binder, and was then sintered at 1,170 to 1,250° C. for 2 hours in air to obtain a sintered body.

Both surfaces of the sintered body were flattened by a lapping machine to a thickness of 0.350 mm. The sintered body was then cut to a size of 15 mm in length and 15 mm in width using a dicing saw, and temporary electrodes (14 mm long×14 mm wide) for polarization were formed on both the upper and lower surfaces. Then, the sintered body was polarized in a thickness-shear direction by applying an electric field of 3 kV/mm for 15 minutes in a silicon oil bath having a temperature of 150° C. The temporary electrodes were then removed. Here, the size of the sample after removing the temporary electrodes was 15 mm in length×15 mm in width×0.35 mm in thickness. The sample was lapped again by a lapping machine to a thickness of about 0.320 mm, and then cut using a dicing saw to have a length of 3.17 mm and a width of 0.55 mm.

The cut samples were heat-treated under the conditions shown in Tables 1 to 4. The heat treatment was conducted in the air atmosphere. The heat treatment was carried out after removal of the temporary electrodes, so as to be able to avoid the removal thereof with a greater difficulty due to a change of the temporary electrode property caused by the heat treatment.

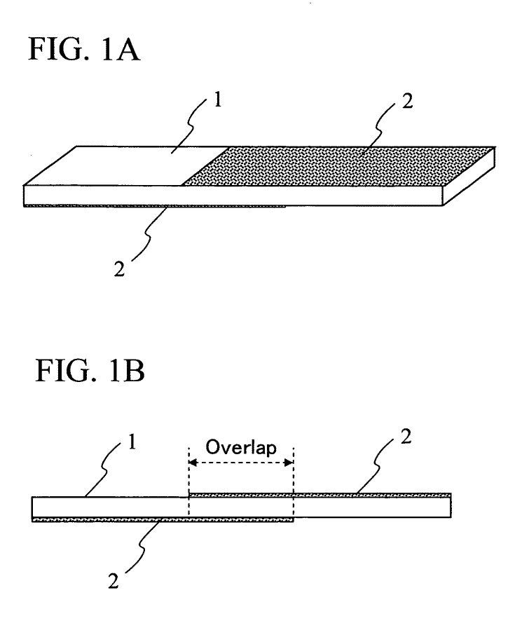

After the heat treatment, as illustrated in FIG. 1A, a sample for measuring was produced by forming vibrating electrodes 2 on both surfaces (both lapped surfaces) of the specimen 1 using a vacuum evaporation apparatus. FIG. 1B illustrates the cross-section of the specimen 1. The overlap of the vibrating electrodes 2 was made to be 1.5 mm. The vibrating electrodes 2 were formed of a 0.01 μm-thick Cr sublayer and a 2 μm-thick Ag layer.

The fracture toughness value k1C of the specimen 1 was measured.

Further, the heat resistance |ΔF₀| for the above specimen 1 was determined. |ΔF₀| was determined by measuring the oscillation frequency F₀ with a frequency counter (53181A manufactured by Agilent Technologies) and calculating according to the above-described formula 1.

The electromechanical coupling factor k₁₅ and the electrical property Qₘₐₓ for the above specimen 1 were also determined.

The above results are shown in Tables 1 to 4.

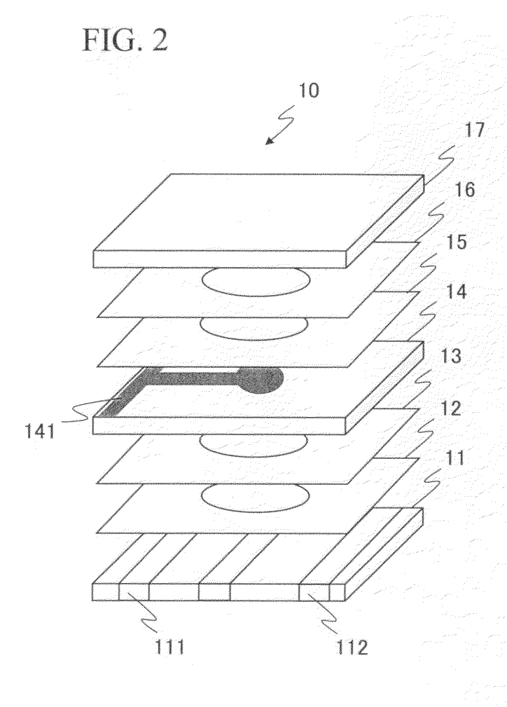

Further, using the above-obtained samples, the resonator illustrated in FIG. 2 was actually fabricated. The impedance and phase curve were measured using the above-described impedance analyzer to determine whether any unnecessary vibrations (spurious vibrations) were present. The resonator 10 illustrated in FIG. 2 has a structure in which, on a substrate 11 provided with terminal electrodes 111 and 112, are successively layered an adhesive resin layer 12, a cavity resin layer 13, a piezoelectric resonator 14 provided with a vibrating electrode 141, a cavity resin layer 15, an adhesive resin layer 16 and a cover 17. The piezoelectric resonator 14 is constituted by the above-described sample. This piezoelectric resonator 14 is supported on the substrate 11 via the adhesive resin layer 12 and the cavity resin layer 13. The cavity resin layers 13 and 15 are disposed to provide a vibration space so that the vibrations confined in the vicinity of the vibrating electrode 141 are not suppressed. To ensure that this space is maintained and ensure its air tightness, the piezoelectric resonator 14 is adhered to the cover 17 by the adhesive resin layer 16.

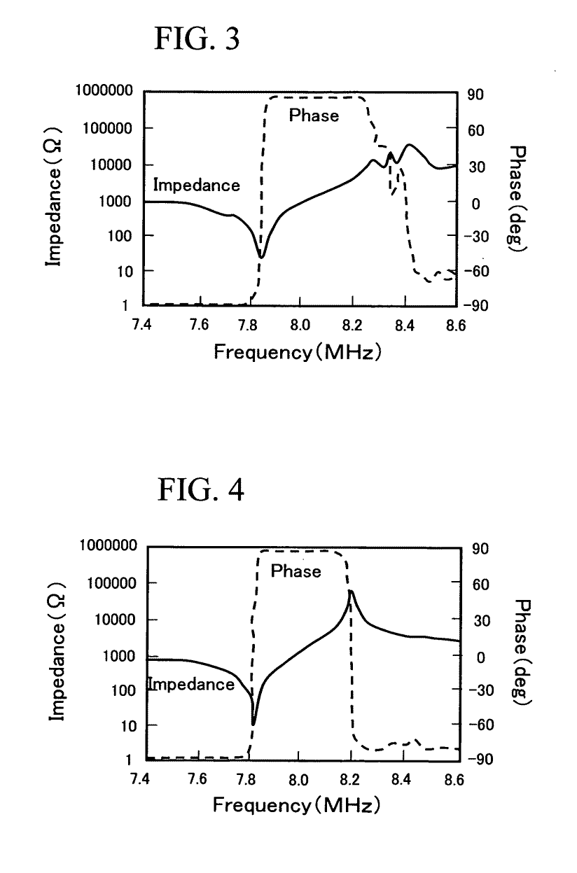

FIG. 3 illustrates the wave form of the impedance and phase curve when spurious vibrations were generated. FIG. 4 illustrates the wave form of the impedance and phase curve when spurious vibrations were not generated.

TABLE 1

| | | | | | | | | Heat | Heat |
|---|---|---|---|---|---|---|---|---|---|
| | Main Component (molar ratio) | | | | | | | Treatment | Treatment |
| Sample | a | b | c | | e | f | Additive | Temperature | Time |
| No. | (Pb) | (Mn) | (Nb) | d | (Ti) | (Zr) | Al₂O₃ (wt %) | (° C.) | (min) |
| 1 | 0.995 | 0.350 | 0.650 | 0.100 | 0.520 | 0.380 | 5 | — | — |
| 2 | 0.995 | 0.350 | 0.650 | 0.100 | 0.520 | 0.380 | 5 | 190 | 30 |
| 3 | 0.995 | 0.350 | 0.650 | 0.100 | 0.520 | 0.380 | 5 | 200 | 30 |
| 4 | 0.995 | 0.350 | 0.650 | 0.100 | 0.520 | 0.380 | 5 | 210 | 30 |
| 5 | 0.995 | 0.350 | 0.650 | 0.100 | 0.520 | 0.380 | 5 | 220 | 30 |
| 6 | 0.995 | 0.350 | 0.650 | 0.100 | 0.520 | 0.380 | 5 | 230 | 30 |
| 7 | 0.995 | 0.350 | 0.650 | 0.100 | 0.520 | 0.380 | 5 | 240 | 30 |
| 8 | 0.995 | 0.350 | 0.650 | 0.100 | 0.520 | 0.380 | 5 | 250 | 30 |
| 9 | 0.995 | 0.350 | 0.650 | 0.100 | 0.520 | 0.380 | 5 | 260 | 30 |
| 10 | 0.995 | 0.350 | 0.650 | 0.100 | 0.520 | 0.380 | 5 | 270 | 30 |
| 11 | 0.995 | 0.350 | 0.650 | 0.100 | 0.520 | 0.380 | 5 | 280 | 30 |
| 12 | 0.995 | 0.350 | 0.650 | 0.100 | 0.520 | 0.380 | 5 | 290 | 30 |
| 13 | 0.995 | 0.350 | 0.650 | 0.100 | 0.520 | 0.380 | 5 | 300 | 30 |
| 14 | 0.995 | 0.350 | 0.650 | 0.100 | 0.520 | 0.380 | 5 | 310 | 30 |

| | | | Electro- | | | |
|---|---|---|---|---|---|---|
| | Fracture | | mechanical | Spurious | | |
| | Toughness | Heat | Coupling | Vibrations | | Electrical |
| Sample | Value k1C | Resistance | Factor | | Not | Property |
| No. | (Pa · m^{1/2}) | \|ΔF₀\| (%) | k₁₅ (%) | Present | Present | Qmax |
| 1 | 2.97 | 0.17 | 37.1 | | ◯ | 110 |
| 2 | 2.98 | 0.11 | 36.9 | | ◯ | 105 |
| 3 | 3.09 | 0.08 | 36.8 | | ◯ | 105 |
| 4 | 3.08 | 0.07 | 36.4 | | ◯ | 103 |
| 5 | 3.21 | 0.05 | 36.1 | | ◯ | 100 |
| 6 | 3.33 | 0.04 | 35.7 | | ◯ | 95 |
| 7 | 3.58 | 0.03 | 35.5 | | ◯ | 91 |
| 8 | 3.93 | 0.03 | 35.4 | | ◯ | 90 |
| 9 | 4.13 | 0.03 | 35.4 | | ◯ | 89 |
| 10 | 4.33 | 0.02 | 35.2 | | ◯ | 89 |
| 11 | 4.57 | 0.02 | 35.1 | | ◯ | 87 |
| 12 | 4.64 | 0.02 | 34.7 | | ◯ | 82 |
| 13 | 4.69 | 0.03 | 34.5 | | ◯ | 80 |

| | | | | | |
|---|---|---|---|---|---|
| 14 | 4.72 | 0.02 | 34.0 | Waveform Defect | 65 |

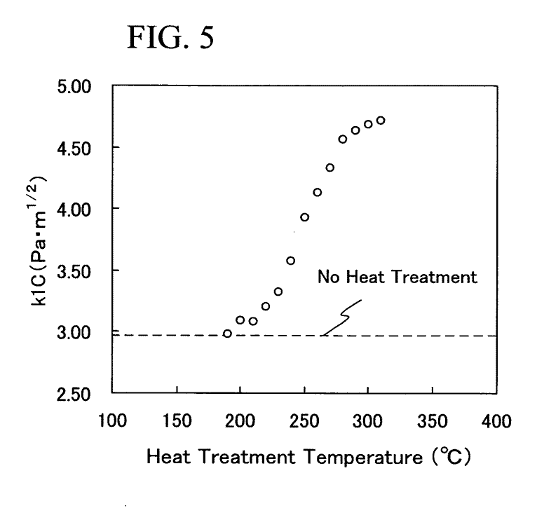

FIG. 5 illustrates the relationship between heat treatment temperature and fracture toughness value k1C, wherein it can be seen that fracture toughness value k1C increases when the heat treatment temperature is 200° C. or more.

As shown in Table 1, the heat resistance |ΔF₀| value becomes smaller the higher the heat treatment temperature becomes, so that it can be seen that the heat treatment of the present invention is effective for heat resistance. Further, the value of the electromechanical coupling factor k₁₅ also becomes smaller the higher the heat treatment temperature becomes, so that it can be seen that the heat treatment of the present invention is suitable for a resonator. However, the electrical property Qₘₐₓ decreases the higher the heat treatment temperature becomes.

In Sample No. 14, since the heat treatment temperature was high, a waveform defect occurred due to deterioration in the impedance property.

TABLE 2

| | | | | | | | | Heat | Heat |
|---|---|---|---|---|---|---|---|---|---|
| | Main Component (molar ratio) | | | | | | | Treatment | Treatment |
| Sample | a | b | c | | e | f | Additive | Temperature | Time |
| No. | (Pb) | (Mn) | (Nb) | d | (Ti) | (Zr) | Al₂O₃ (wt %) | (° C.) | (min) |
| 15 | 0.995 | 0.350 | 0.650 | 0.100 | 0.520 | 0.380 | 5 | 280 | 0 |
| 16 | 0.995 | 0.350 | 0.650 | 0.100 | 0.520 | 0.380 | 5 | 280 | 10 |
| 17 | 0.995 | 0.350 | 0.650 | 0.100 | 0.520 | 0.380 | 5 | 280 | 20 |
| 18 | 0.995 | 0.350 | 0.650 | 0.100 | 0.520 | 0.380 | 5 | 280 | 30 |
| 19 | 0.995 | 0.350 | 0.650 | 0.100 | 0.520 | 0.380 | 5 | 280 | 40 |
| 20 | 0.995 | 0.350 | 0.650 | 0.100 | 0.520 | 0.380 | 5 | 280 | 50 |
| 21 | 0.995 | 0.350 | 0.650 | 0.100 | 0.520 | 0.380 | 5 | 280 | 60 |

| | | | Electro- | | | |
|---|---|---|---|---|---|---|
| | Fracture | | mechanical | Spurious | | |
| | Toughness | Heat | Coupling | Vibrations | | Electrical |
| Sample | Value k1C | Resistance | Factor | | Not | Property |
| No. | (Pa · m^{1/2}) | \|ΔF₀\| (%) | k₁₅ (%) | Present | Present | Qmax |
| 15 | 2.97 | 0.17 | 37.1 | | ◯ | 110 |
| 16 | 4.10 | 0.03 | 35.2 | | ◯ | 90 |
| 17 | 4.56 | 0.03 | 35.1 | | ◯ | 89 |
| 18 | 4.57 | 0.02 | 35.1 | | ◯ | 87 |
| 19 | 4.67 | 0.03 | 35.3 | | ◯ | 84 |
| 20 | 4.57 | 0.03 | 35.2 | | ◯ | 82 |
| 21 | 4.50 | 0.02 | 35.1 | | ◯ | 81 |

From Table 2, it can be seen that the effects of an improvement in fracture toughness value k1C are exhibited at a heat treatment time of 10 to 60 minutes, although the effects of an improvement in fracture toughness value k1C are especially marked at 20 minutes and more. However, the effects of an improvement in fracture toughness value k1C decrease after peaking at a heat treatment time of 40 minutes. On the other hand, the electrical property Qₘₐₓ decreases as the heat treatment times becomes longer. To combine both fracture toughness value k1C and electrical property Qₘₐₓ, the heat treatment time is preferably set at 40 minutes or less.

TABLE 3

| | | | | | | | | Heat | Heat |
|---|---|---|---|---|---|---|---|---|---|
| | Main Component (molar ratio) | | | | | | | Treatment | Treatment |
| Sample | a | b | c | | e | f | Additive | Temperature | Time |
| No. | (Pb) | (Mn) | (Nb) | d | (Ti) | (Zr) | Al₂O₃ (wt %) | (° C.) | (min) |
| 22 | 0.995 | 0.350 | 0.650 | 0.100 | 0.520 | 0.380 | 0 | 280 | 30 |
| 23 | 0.995 | 0.350 | 0.650 | 0.100 | 0.520 | 0.380 | 1 | 280 | 30 |
| 24 | 0.995 | 0.350 | 0.650 | 0.100 | 0.520 | 0.380 | 2 | 280 | 30 |
| 25 | 0.995 | 0.350 | 0.650 | 0.100 | 0.520 | 0.380 | 3 | 280 | 30 |
| 26 | 0.995 | 0.350 | 0.650 | 0.100 | 0.520 | 0.380 | 4 | 280 | 30 |
| 27 | 0.995 | 0.350 | 0.650 | 0.100 | 0.520 | 0.380 | 5 | 280 | 30 |
| 28 | 0.995 | 0.350 | 0.650 | 0.100 | 0.520 | 0.380 | 6 | 280 | 30 |
| 29 | 0.995 | 0.350 | 0.650 | 0.100 | 0.520 | 0.380 | 7 | 280 | 30 |
| 30 | 0.995 | 0.350 | 0.650 | 0.100 | 0.520 | 0.380 | 8 | 280 | 30 |
| 31 | 0.995 | 0.350 | 0.650 | 0.100 | 0.520 | 0.380 | 9 | 280 | 30 |
| 32 | 0.995 | 0.350 | 0.650 | 0.100 | 0.520 | 0.380 | 10 | 280 | 30 |
| 33 | 0.995 | 0.350 | 0.650 | 0.100 | 0.520 | 0.380 | 11 | 280 | 30 |

| | | | Electro- | | | |
|---|---|---|---|---|---|---|
| | Fracture | | mechanical | Spurious | | |
| | Toughness | Heat | Coupling | Vibrations | | Electrical |
| Sample | Value k1C | Resistance | Factor | | Not | Property |
| No. | (Pa · m^{1/2}) | \|ΔF₀\| (%) | k₁₅ (%) | Present | Present | Qmax |
| 22 | 3.27 | 0.07 | 40.5 | ◯ | | 120 |
| 23 | 3.85 | 0.04 | 39.0 | | ◯ | 113 |
| 24 | 4.25 | 0.04 | 38.6 | | ◯ | 107 |
| 25 | 4.48 | 0.02 | 37.0 | | ◯ | 100 |
| 26 | 4.57 | 0.03 | 36.6 | | ◯ | 93 |
| 27 | 4.57 | 0.02 | 35.1 | | ◯ | 87 |
| 28 | 4.51 | 0.03 | 34.7 | | ◯ | 81 |
| 29 | 4.42 | 0.02 | 33.1 | | ◯ | 74 |
| 30 | 4.41 | 0.03 | 32.7 | | ◯ | 67 |
| 31 | 4.39 | 0.03 | 31.2 | | ◯ | 60 |
| 32 | 4.35 | 0.03 | 30.8 | | ◯ | 54 |
| 33 | 4.31 | 0.04 | 28.8 | | ◯ | 40 |

From Table 3, it can be seen that the occurrence of spurious vibrations can be prevented by including Al₂O₃. Further, Table 3 also shows that the fracture toughness value k1C increases by including Al₂O₃. However, there is no correlation between the amount of Al₂O₃ and fracture toughness value k1C in the range of more than 2 wt %.

Heat resistance also improves by including Al₂O₃. In the range of more than 2 wt % and 10 wt % or less, the heat resistance |ΔF₀| is 0.03% or less.

Further, the electromechanical coupling factor k₁₅ decreases in proportion to the increase in the amount of Al₂O₃. On the other hand, the electrical property Qₘₐₓ also decreases in proportion to the increase in the amount of Al₂O₃. If the amount of Al₂O₃ is 11 wt %, the electrical property Qₘₐₓ is 40%, which is a low value. Therefore, the amount of Al₂O₃ in the present invention is 10 wt % or less.

TABLE 4

| | | | | | | | | Heat | Heat |
|---|---|---|---|---|---|---|---|---|---|
| | Main Component (molar ratio) | | | | | | | Treatment | Treatment |
| Sample | a | b | c | | e | f | Additive | Temperature | Time |
| No. | (Pb) | (Mn) | (Nb) | d | (Ti) | (Zr) | Al₂O₃ (wt %) | (° C.) | (min) |
| 34 | 0.995 | 0.333 | 0.667 | 0.100 | 0.520 | 0.380 | 5 | — | — |
| 35 | 0.995 | 0.333 | 0.667 | 0.100 | 0.520 | 0.380 | 5 | 280 | 30 |
| 36 | 0.995 | 0.340 | 0.660 | 0.100 | 0.520 | 0.380 | 5 | — | — |
| 37 | 0.995 | 0.340 | 0.660 | 0.100 | 0.520 | 0.380 | 5 | 280 | 30 |
| 38 | 0.995 | 0.345 | 0.655 | 0.100 | 0.520 | 0.380 | 5 | — | — |
| 39 | 0.995 | 0.345 | 0.655 | 0.100 | 0.520 | 0.380 | 5 | 280 | 30 |
| 40 | 0.995 | 0.350 | 0.650 | 0.100 | 0.520 | 0.380 | 5 | — | — |
| 41 | 0.995 | 0.350 | 0.650 | 0.100 | 0.520 | 0.380 | 5 | 280 | 30 |
| 42 | 0.995 | 0.375 | 0.625 | 0.100 | 0.520 | 0.380 | 5 | — | — |
| 43 | 0.995 | 0.375 | 0.625 | 0.100 | 0.520 | 0.380 | 5 | 280 | 30 |
| 44 | 0.995 | 0.384 | 0.616 | 0.100 | 0.520 | 0.380 | 5 | 280 | 30 |
| 45 | 0.995 | 0.350 | 0.650 | 0.100 | 0.500 | 0.400 | 5 | 280 | 30 |
| 46(41) | 0.995 | 0.350 | 0.650 | 0.100 | 0.520 | 0.380 | 5 | 280 | 30 |
| 47 | 0.995 | 0.350 | 0.650 | 0.100 | 0.540 | 0.360 | 5 | 280 | 30 |
| 48 | 0.980 | 0.350 | 0.650 | 0.100 | 0.520 | 0.380 | 5 | 280 | 30 |
| 49 | 0.990 | 0.350 | 0.650 | 0.100 | 0.520 | 0.380 | 5 | 280 | 30 |
| 50(41) | 0.995 | 0.350 | 0.650 | 0.100 | 0.520 | 0.380 | 5 | 280 | 30 |
| 51 | 1.010 | 0.350 | 0.650 | 0.100 | 0.520 | 0.380 | 5 | 280 | 30 |
| 52 | 0.995 | 0.350 | 0.650 | 0.080 | 0.510 | 0.410 | 5 | 280 | 30 |
| 53 | 0.995 | 0.350 | 0.650 | 0.080 | 0.520 | 0.400 | 5 | 280 | 30 |
| 54(41) | 0.995 | 0.350 | 0.650 | 0.100 | 0.520 | 0.380 | 5 | 280 | 30 |
| 55 | 0.995 | 0.350 | 0.650 | 0.120 | 0.510 | 0.370 | 5 | 280 | 30 |
| 56 | 0.995 | 0.350 | 0.650 | 0.120 | 0.520 | 0.360 | 5 | 280 | 30 |

| | | | Electro- | | | |
|---|---|---|---|---|---|---|
| | Fracture | | mechanical | Spurious | | |
| | Toughness | Heat | Coupling | Vibrations | | Electrical |
| Sample | Value k1C | Resistance | Factor | | Not | Property |
| No. | (Pa · m^{1/2}) | \|ΔF₀\| (%) | k₁₅ (%) | Present | Present | Qmax |
| 34 | 2.01 | 0.10 | 37.0 | | ◯ | 102 |
| 35 | 3.56 | 0.09 | 35.6 | | ◯ | 109 |
| 36 | 2.12 | 0.05 | 36.9 | | ◯ | 111 |
| 37 | 4.42 | 0.03 | 35.3 | | ◯ | 92 |
| 38 | 2.50 | 0.04 | 36.7 | | ◯ | 105 |
| 39 | 4.49 | 0.03 | 35.2 | | ◯ | 90 |
| 40 | 2.85 | 0.03 | 36.5 | | ◯ | 102 |
| 41 | 4.57 | 0.02 | 35.1 | | ◯ | 87 |
| 42 | 2.95 | 0.04 | 36.1 | | ◯ | 103 |
| 43 | 4.51 | 0.03 | 34.95 | | ◯ | 90 |
| 44 | 4.32 | 0.03 | 34.9 | | ◯ | 89 |
| 45 | 4.40 | 0.03 | 36.3 | | ◯ | 92 |
| 46(41) | 4.57 | 0.02 | 35.1 | | ◯ | 87 |
| 47 | 4.35 | 0.02 | 34.5 | | ◯ | 75 |
| 48 | 4.42 | 0.03 | 34.8 | | ◯ | 105 |
| 49 | 4.51 | 0.03 | 36.1 | | ◯ | 98 |
| 50(41) | 4.57 | 0.02 | 35.1 | | ◯ | 87 |
| 51 | 4.52 | 0.05 | 37.0 | | ◯ | 120 |
| 52 | 4.42 | 0.03 | 36.1 | | ◯ | 97 |
| 53 | 4.49 | 0.03 | 35.8 | | ◯ | 90 |
| 54(41) | 4.57 | 0.02 | 35.1 | | ◯ | 87 |
| 55 | 4.49 | 0.03 | 35.1 | | ◯ | 81 |
| 56 | 4.51 | 0.02 | 34.8 | | ◯ | 73 |

In Table 4, although No. 34 and No. 35 are piezoelectric ceramics with an identical composition, the latter were subjected to a heat treatment (280° C.×30 minutes) and the former were not subjected to a heat treatment. Same explanations apply to No. 36 and No. 37, No. 38 and No. 39, No. 40 and No. 41, and No. 42 and No. 43. No. 34 and No. 35 are examples in which the Mn and Nb are present in stoichiometric amounts (Mn_{1/3}Nb_{2/3}). No. 36 and No. 37, No. 38 and No. 39, No. 40 and No. 41, and No. 42 and No. 43 are examples in which the Mn is richer than in the stoichiometric amount and the Nb is poorer than in the stoichiometric amount. For convenience, in the latter examples, the Mn and Nb will be represented to be non-stoichiometric”.

Whether the Mn and Nb were stoichiometric (No. 34 and No. 35) or non-stoichiometric (No. 36 and No. 37, and No. 38 and No. 39, No. 40 and No. 41, and No. 42 and No. 43), the fracture toughness value k1C were increased by the heat treatment of the present invention. However, comparison of the stoichiometric Mn and Nb cases with the non-stoichiometric cases shows that the non-stoichiometric cases had a higher increase in fracture toughness value k1C.

Next, looking at the relationship between b (Mn amount) and heat resistance |ΔF₀|, if b increases, heat resistance |ΔF₀| improves. Specifically, it can be seen that excellent heat resistance of |ΔF₀| of 0.05% or less is exhibited if the Mn is in the range of 0.340≦b≦0.384 (Nos. 37, 39, 41, 43 and 44), whereas |ΔF₀| is 0.09% if b is 0.333 (c is 0.667, No. 35) wherein Mn is a stoichiometric composition. However, if b is further increased, polarization becomes impossible. In the present invention, therefore, b is defined as 0.340≦b≦0.384.

Further, from Table 4 it can be seen that the electromechanical coupling factor k₁₅ tends to decrease if b increases. When the inventive piezoelectric ceramic is to be used as a resonator, a smaller electromechanical coupling factor k₁₅ is more preferable.

Looking at a (Pb amount), the electromechanical coupling factor k₁₅ tends to increase as a increases, although the electromechanical coupling factor k₁₅ can be 37.0% or less in the range (0.98≦a≦1.01) according to the present invention. Further, in this range, an electrical property Qₘₐₓ of 80 or more can be obtained.

Similarly for d, e (Ti amount) and f (Zr amount), in the ranges (0.08≦d≦0.12, 0.500≦e≦0.540, 0.37≦f≦0.41) according to the present invention, an electromechanical coupling factor k₁₅ of 37.0% or less and an electrical property Qₘₐₓ of 80 or more were confirmed, thus exhibiting values which would have no problems in practical use as a resonator or other such applications.

What is claimed is:

1. A method for producing a piezoelectric ceramic comprising the steps of:
polarizing a piezoelectric ceramic comprising a main component represented by a composition formula Pbₐ[(Mn_{b}Nb_{c})_{d}TiₑZr_{f}]O₃, wherein a to f satisfy:
0.98≦a≦1.01,
0.340≦b≦0.384,
0.616≦c≦0.660,
0.08≦d≦0.12,
0.500≦e≦0.540,
0.37≦f≦0.41, and
bd+cd+e+f=1,
and 1 to 10% by weight of Al in terms of Al₂O₃ as an additive; and
heat-treating the polarized piezoelectric ceramic for 10 to 60 minutes in a range of 200 to 300° C.

2. The method for producing a piezoelectric ceramic according to claim 1, wherein the polarized piezoelectric ceramic is heat-treated in a range of 260 to 300° C.

3. The method for producing a piezoelectric ceramic according to claim 1, wherein the polarized piezoelectric ceramic is heat-treated for 20 to 40 minutes.

4. The method for producing a piezoelectric ceramic according to claim 1, wherein the polarized piezoelectric ceramic is heat-treated for 20 to 40 minutes.

5. The method for producing a piezoelectric ceramic according to claim 1, wherein the piezoelectric ceramic comprises 2 to 6% by weight of Al in terms of Al₂O₃ as an additive.
